(19) United States
(12) Patent Application Publication
(10) Pub. No.: US 2014/0320342 A1
(43) Pub. Date: Oct. 30, 2014

(54) The Body Armor Enhancement (BAE)

(71) Applicants: William Glenn Parker, Flatonia, TX (US); William Clayton Parker, Flatonia, TX (US)

(72) Inventors: William Glenn Parker, Flatonia, TX (US); William Clayton Parker, Flatonia, TX (US)

(21) Appl. No.: 13/873,615

(22) Filed: Apr. 30, 2013

(51) Int. Cl. G01S 19/18

(52) U.S. Cl. CPC G01S 19/18
USPC 342/357.56

(57) ABSTRACT

A body armor enhancement according to the present invention comprises global positioning system (GPS) unit, a pressure switch, and a wire mesh/non-conductive covering trauma activated switch being on top of or beneath a soldier's Kevlar and ballistic plates. The soldier can depress the pressure switch to activate the GPS tracking unit thus displaying his location to command and notifying them of his duress and exact location. The GPS unit can also be activated by the impact of firearm fired projectiles such as bullets so that even after the soldier gets injured and/or loses ability to depress the pressure switch; their location can be tracked via GPS unit. In addition to protection offered by the Kevlar covering and ballistic plates, the body armor enhancement helps to locate injured soldiers or soldiers who got kidnapped or are missing in action.

### BACKGROUND OF THE INVENTION

1. Field of the Invention

The present invention relates to a device for remotely locating military personnel, and more particularly to a body armor enhancement comprising a global positioning system (GPS) tracking unit, a pressure switch, and a wire mesh/non-conductive covering on top of or beneath a soldier's Kevlar and ballistic plate in order to transmit soldiers' location for reporting injury, getting medical support, and/or other purposes in addition to protection offered by the Kevlar covering and ballistic plates.

2. Description of Related Art

During battles there are numerous scenarios that may cause deaths, both direct and indirect. These include those kidnapped in a shootout, missing in action, fratricide (deaths from friendly fire), or death resulting from delay in locating casualties, etc. These scenarios if properly handled in time would spare many lives. However, because the soldiers are still left with 1980's technology when it comes to reporting an injury, one can only hope that when they fall, there's a fellow soldier nearby to radio in for medical support and backup. If a soldier gets injured and/or loses consciousness when there's no fellow soldier nearby, the injured soldier may be left to die without anyone knowing of the situation.

In recent years, global position technology has developed for precisely geographically locating objects and/or individuals. Utilization of GPS and wireless communication for locating the whereabouts of civilians has gained popular application. Despite U.S. and allied military already apply the secure GPS Precise Positioning Service to navigation, target tracking, missile and projectile guidance, search and rescue of downed pilot, etc., GPS tracking unit is still not common equipment for soldiers to carry in battlefields even though GPS technology is mentioned in several patents for monitoring soldier's whereabouts in the battlefields.

Body armor is worn on a torso to help absorb the impact from firearm-fired projectiles and shrapnel from explosions. Soft vests are made from many layers of woven or laminated fibers and can be capable of protecting the wearer from small-caliber handgun. Kevlar is the registered trademark for a high strength synthetic fiber and is a well-known component of ballistic vests. Metal or ceramic plates can be used with a soft vest, providing additional protection from rifle rounds. Hard-plate reinforced vests are mainly worn by combat soldiers.

Generally, the body armors do not provide any functionality beyond impact protection for the individuals wearing them. Because the body armors are usually worn by the soldiers in the battlefields, it is ideal equipment to associate with when tracking soldiers in the battlefields. Thus, integrating a position locating system with body armor provides an efficient method for locating an injured soldier in the battlefield.

By way of example, U.S. Pat. No. 7,805,767 B2 to McElroy et al. discloses a body armor plate having integrated electronic modules. The plate comprises a geo-location module and wireless transmission/reception module to form a Global Positioning Satellite (“GPS”) sensor that receives communications from one or more satellites, and determines a geo-location of plate from the received communications. Although the device further comprises impact sensor, and the power charging and storage module, the invention does not provide solution to the problem described below.

When the GPS system is left inactive, the battery can last for a long time. However, once the GPS system is activated, the battery life dramatically decreases. In the battlefields, there may not be an opportunity to recharge batteries. Thus, in order to conserve the life of the battery power supply, the GPS system may stay inactive during a combat before confronting enemies. Moreover, if the GPS units for all soldiers are activated in the battlefield, the command or medical support cannot distinguish who are injured and need help and who are not. Thus, it makes sense that the GPS tracking unit stays inactive until the soldier needs backup or gets injured and needs medical support. So, their request can get attention. A GPS tracking unit for soldiers in the battlefields can work like a 911 call for civilians. However, after a soldier gets injured, they may lose consciousness or mobility to activate the GPS tracking unit.

Therefore, there is a need for a device that can activate the GPS tracking unit at once when soldiers get injured in the battlefields. The proposed body armor enhancement in the present application meets the need.

### SUMMARY OF THE INVENTION

One object of the present invention is to provide a device that helps to report immediate injury if a soldier gets injured in the battlefield.

Another object of the present invention is to provide a device that integrates body armor and GPS technology so that the injured soldier may be easily located.

Yet a further object of the present invention is to provide a device that can activate a GPS tracking unit at once when a soldier gets injured.

The Body Armor Enhancement (BAE) according to the present invention comprises three components:
1.) GPS tracking unit;
2.) Pressure switch (for manual activation); and
3.) Wire mesh/non-conductive covering trauma activated switch (for bullet impact activation).

The GPS tracking unit of the present invention may be activated by manual and/or by the impact from firearm fired projectiles. The soldier can depress the pressure switch to activate the GPS tracking unit thus displaying his location to command and notifying them of his duress and exact location.

To ensure that even after the soldiers lose consciousness or mobility after they get injured, their location can be tracked; the device provides additional mechanism to activate the GPS unit. The wire mesh/non-conductive covering trauma activated switch (“wire mesh/non-conductive covering” hereafter) comprises two wire mesh screens separated by a thin non-conductive barrier being the outermost covering on the soldier's Kevlar and ballistic plates in one embodiment. In another embodiment, the wire mesh/non-conductive covering is located beneath the soldier's Kevlar and ballistic plates. The non-conductive barrier prevents the two wire mesh screens from being in contact with one another so as to prevent the activation of GPS tracking unit until the soldier is impacted by fire-arm fired projectile (e.g. bullets). When the soldier is impacted by bullet, the thin non-conductive barrier is punctured, thus completing the circuit when the wire mesh screens comes in contact with one another, turning on the GPS tracking unit as if the soldier had depressed the pressure switch.

The wire mesh screens including electrical wires may include one or more electrically conductive materials (e.g. aluminum, copper, and/or other materials known in the art). The thin non-conductive barrier may be made of synthetic rubber and/or other suitable materials known in the art. The wire mesh screens may be permanently or releasably connected (physical and electrical) to the GPS tracking unit. Once the thin non-conductive barrier is ruptured, the wire mesh screens come in contact with one another, the circuit is completed; the electricity from power supply turns on the GPS tracking unit.

The GPS tracking unit includes a GPS receiver and processor, a wireless communication component, and a power supply. The GPS receiver and processor, and wireless communication component are each interconnected to the power supply.

Once the GPS tracking unit is activated, the GPS receiver and processor will receive signals (frequencies) that are transmitted from GPS Satellites, Global System for Mobile Communications (GSM), General packet radio service (GPRS) and/or combinations thereof and determine the geo-location of the soldier based on the received signals. The wireless communication component will then communicate the location of the soldier to command, medical support, backup and/or target acquisitioning system for display on a digital map, or by sms text providing the distressed soldier's coordinates in latitude and longitude. This capability interfaced with the target acquisitioning systems would eliminate or greatly reduce the risk of close fire missions from aircraft to support ground troop personnel. The GPS tracking unit may further include a display for providing location on a map to the soldier. The GPS tracking unit is shockproof and waterproof. The GPS tracking unit is preferably about 46 grams in weight and about 50 mm×40 mm×20 mm in dimensions. The weight and dimension of the GPS tracking unit may vary. The GPS tracking unit described here may be comprised of commercially and/or military available parts. The GPS tracking unit may also include technologies known in the art currently and in the future.

In one embodiment, the GPS tracking unit attaches to the base of the neck with the manual pressure switch being located to either side of the neck. In another embodiment, the GPS tracking unit further includes an on/off switch, which is located on either side of the GPS tracking unit. The GPS tracking unit may be located on any place of soldier's body and/or connected to any place of the wire mesh screens as long as the manual pressure switch and/or on/off button can be reached by the soldiers. In one embodiment, the GPS tracking unit is permanently connected via electrical wire to the wire mesh screens of the body armor enhancement. In another embodiment, the GPS tracking unit is releasably connected to the wire mesh screens of the body armor enhancement such that they can be disconnected for separate storage.

The power supply includes but not limited to one and/or more rechargeable batteries. When the GPS tracking unit is left inactivated the unit would remain in “stand by” mode for up to about two years. Once the GPS tracking unit is activated, the battery life is up to about 2 weeks. As understood by those in the art, the power supply may be comprised of commercially available rechargeable batteries.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of an embodiment of a body armor enhancement according to the present invention;

FIG. 2 is an exploded view of the wire mesh/synthetic rubber covering Trauma Activated Switch according to the present invention; and

FIG. 3 illustrates a back view of a soldier wearing the body armor enhancement of the present invention.

### DESCRIPTION OF THE PREFERRED EMBODIMENT

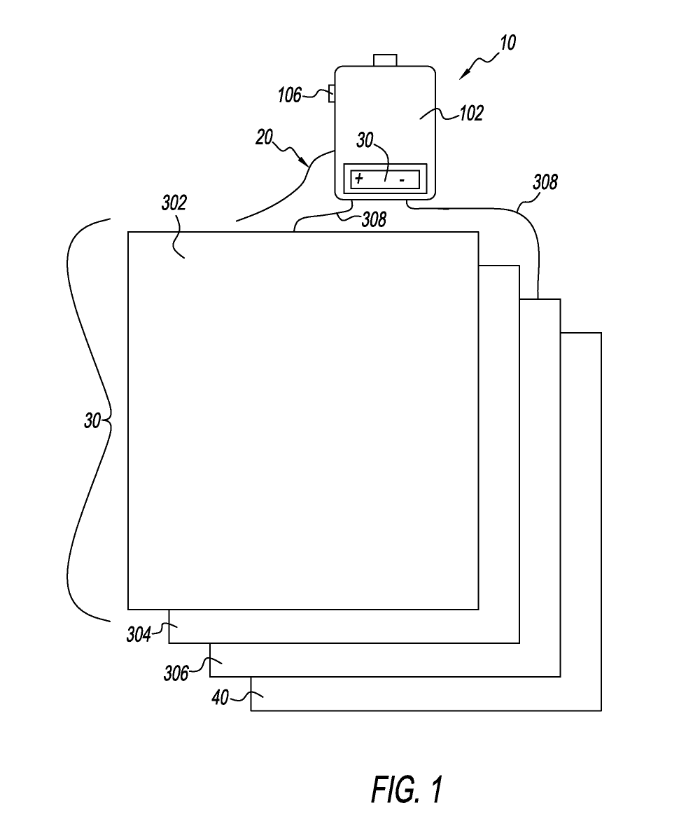

Referring to FIG. 1, there is disclosed an embodiment of a body armor enhancement 1 according to the present invention. The body armor enhancement 1 comprises a GPS tracking unit 10, a pressure switch 20, and a wire mesh/non-conductive covering 30 being on the outermost of a soldier's Kevlar and ballistic plate 40. The pressure switch 20 is located on the left side of the GPS tracking unit 10 for soldiers to depress in order to activate the GPS tracking unit 10. In another embodiment, the pressure switch 20 is located on the right side of the GPS tracking unit 10. The GPS tracking unit 10 includes a GPS receiver and processor 102 for receiving signals (frequencies) transmitted from GPS satellites, GSM, GPRS, and/or combinations thereof, and determining the geo-location of the soldier wearing the receiver 102, a power supply 104, and a wireless component 106 for transmitting the geo-location of the soldier to the command, medical support or backup through a wireless network. The GPS receiver and processor 102, and wireless communication component 106 are each interconnected to the power supply 104.

The wire mesh/non-conductive covering 30 includes two wire mesh screens, 302 and 306, which are connected via electrical wire 308 to the GPS tracking unit 10 and separated by a thin synthetic rubber barrier 304. When the synthetic rubber barrier 304 is intact, the two wire mesh screens, 302 and 306, are isolated from one another, and thus the circuit is not completed; the GPS tracking unit 10 stays inactive. Once a bullet passing through the mesh 302, the thin synthetic rubber 304 will be punctured, the two wire mesh screens, 302 and 306, come into contact with one another; the circuit loop is completed, the GPS tracking unit 10 is turned on (activated). In one embodiment, the wire connection between GPS tracking unit 10 and the two wire mesh screens, 302 and 306, is permanent. In another embodiment, the GPS tracking unit 10 and the wire mesh screens, 302 and 306, are releasably connected and may be disconnected for easy storage. In some embodiments, the GPS tracking unit 10 has an on/off switch 106 on either side. In some embodiments, the wire mesh/non-conductive covering 30 may be located beneath the soldiers Kevlar and ballistic plate 40.

The wire mesh screens, 302 and 306, may include one or more conductive materials (e.g. aluminum, copper, and/or other materials known in the art). The thin non-conductive barrier 304 may be made of synthetic rubber and/or other suitable materials known in the art.

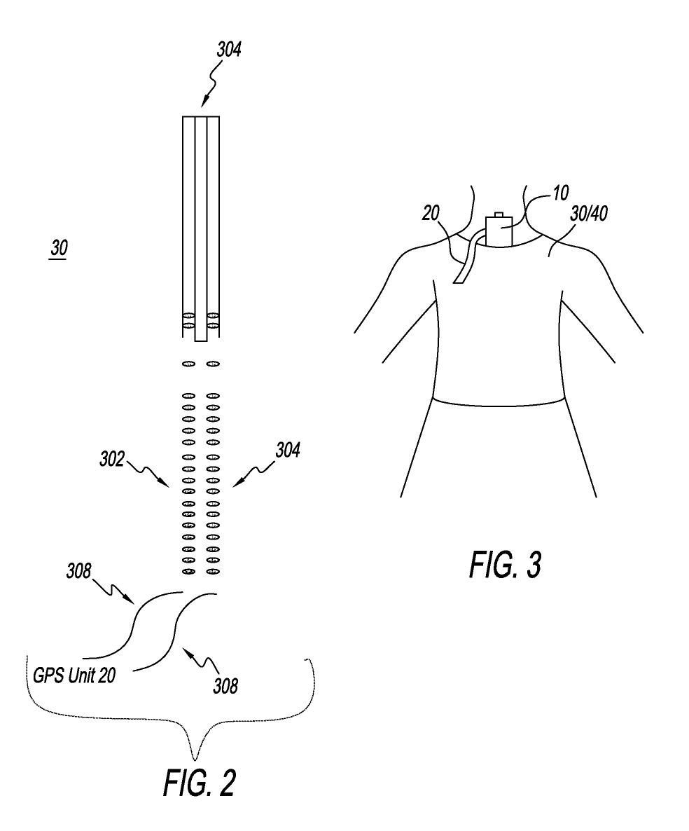

FIG. 2 illustrates an exploded view of the aluminum wire mesh/synthetic rubber covering 30, which works as a trauma (impact) activated switch. The wire mesh/synthetic rubber covering 30 includes two aluminum wire mesh screens, 302 and 306, which have electrical wires 308 leading to GPS tracking unit 10, separated by a thin synthetic rubber barrier 304. The synthetic rubber barrier 304 inhibits the two aluminum wire mesh screen 302 and 306 in contact with one another, and thus the GPS unit 10 is inactive. Once a bullet passing through the mesh 302 will puncture the synthetic rubber barrier 304 and thus complete the circuit, activating the GPS tracking unit 10.

FIG. 3 illustrates a back view of a soldier wearing the body armor enhancement 1, where the GPS tracking unit 10 is attached to the wire mesh/non-conductive covering 30 of the body armor 1 and is located on the base of the soldier's neck. The electrical wire 308 between the GPS tracking unit 10 and the wire mesh/non-conductive covering 30 are not exposed.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A body armor enhancement device comprising:
(a) a GPS tracking unit including a GPS receiver and processor, a wireless communication component, and a power supply;
(b) a pressure switch for soldiers to manually activate the GPS tracking unit being electrically connected to the GPS tracking unit; and
(c) a wire mesh/non-conductive covering for activating GPS tracking unit by impact of firearm fired projectiles, being electrically connected to the GPS tracking unit.

2. The body armor enhancement device of claim 1, wherein the GPS tracking unit attaches to the base of the neck with the manual pressure switch being located to either side of the neck.

3. The body armor enhancement device of claim 1, wherein the GPS tracking unit may be disconnected from the wire mesh/non-conductive covering for separate storage.

4. The body armor enhancement device of claim 1, wherein the power supply is rechargeable battery.

5. The body armor enhancement device of claim 1, wherein the activated GPS tracking unit will receive signals from GPS, GSM, GPRS, and/or combinations thereof.

6. The body armor enhancement device of claim 1, wherein the activated GPS tracking unit will transmit the location of the soldier for display on a digital map, or by sms text to cellular device of the distressed soldiers coordinates in latitude and longitude.

7. The body armor enhancement device of claim 1, wherein the wire mesh/ non-conductive covering comprises two wire mesh screens separated by a thin non-conductive barrier.

8. The body armor enhancement device of claim 7, wherein the non-conductive barrier is made of synthetic rubber.

9. The body armor enhancement device of claim 7, wherein the wire mesh screens are made of conductive material including but not limited to aluminum.

10. A body armor enhancement device comprising:
(a) a GPS tracking unit including a GPS receiver and processor, a wireless communication component, and a power supply;
(b) a pressure switch for soldiers to manually activate the GPS tracking unit being electrically connected to the GPS tracking unit;
(c) a wire mesh/non-conductive covering for activating GPS tracking unit by impact of firearm fired projectiles, being electrically connected to the GPS tracking unit; and
(d) a soldier's Kevlar and a ballistic plate for absorbing impact from fire-armed projectiles and providing wearer protection from projectiles.

11. The body armor enhancement device of claim 10, wherein the wire mesh/non-conductive covering is located on the outermost of the body armor.

12. The body armor enhancement of claim 10, wherein the wire mesh/synthetic rubber covering is located beneath the soldier's Kevlar and ballistic plate.

13. The body armor enhancement device of claim 10, wherein the power supply is rechargeable battery.

14. The body armor enhancement device of claim 10, wherein the activated GPS tracking unit will receive signals from GPS, GSM, GPRS, and/or combinations thereof.

15. The body armor enhancement device of claim 10, wherein the activated GPS unit will transmit the location of the soldier for display on a digital map, or by sms text to cellular device of the distressed soldiers coordinates in latitude and longitude.

16. The body armor enhancement device of claim 10, wherein the wire mesh/ non-conductive covering comprises two wire mesh screens separated by a thin non-conductive barrier.

17. The body armor enhancement device of claim 16, wherein the non-conductive barrier is made of synthetic rubber.

18. The body armor enhancement device of claim 16, wherein the wire mesh screens are made of conductive material including but not limited to aluminum.

19. The body armor enhancement device of claim 10, wherein the GPS tracking unit further includes a display for providing location on a map to the soldier.

20. The body armor enhancement device of claim 10, wherein the GPS tracking unit may be disconnected from the wire mesh/non-conductive covering for separate storage.
